(19) United States
(12) Patent Application Publication
(10) Pub. No.: US 2018/0051844 A1
(43) Pub. Date: Feb. 22, 2018

(54) MAGNETIC FLANGE PROTECTOR

(71) Applicant: Joshua Yeater, Liberty, TX (US)

(72) Inventor: Joshua Yeater, Liberty, TX (US)

(21) Appl. No.: 15/680,811

(22) Filed: Aug. 18, 2017

Related U.S. Application Data
(60) Provisional application No. 62/377,040, filed on Aug. 19, 2016.

(51) Int. Cl. F16L 57/00

(52) U.S. Cl. CPC F16L 57/005; B65D 59/06

(57) ABSTRACT

A magnetic flange protector for protecting the surface of a flange. The magnetic flange protector includes a planar member having an upper surface and a lower surface, a handle secured to the upper surface of the planar member, and a magnet secured to the lower surface of the planar member. The handle has a first end and a second end, wherein each end is secured to the upper surface. The magnet is secured to the lower surface of the planar member within a recessed area, thereby allowing the lower surface to rest flush against and cover a gasket face surface of a flange. In an alternate embodiment, the planar member is circular, wherein a concentric annular seal is secured to the lower surface, and the handle is arcuately shaped.

### CROSS REFERENCE TO RELATED APPLICATION

This application claims the benefit of U.S. Provisional Application No. 62/377,040 filed on Aug. 19, 2016. The above identified patent application is herein incorporated by reference in its entirety to provide continuity of disclosure.

### BACKGROUND OF THE INVENTION

The present invention relates to flange protectors. More specifically, the present invention provides a magnetic flange protector for temporary application to the flange end of a pipe, valve, or other conduit as to protect the machined surface of the flange from damage.

A flange is an external or internal ridge or rim typically welded to a pipe used for mating two flanged pipes together. Typically, flanges are made from a ferrous metal, such as steel. Such flanges are made according to ASA standards and are characterized by a hub, which may be connected to or integral with a pipe or valve, a flange integral with the hub and having bolt holes for bolting it to a mating flange to make a fluid tight connection, and a machined gasket face surface on the flange, whereby a gasket is placed against and compressed when the flanges are bolted together. The gasket face surface of the flange will typically be finely machined to ensure a tight seal between the mating flange surfaces and the compressed sealing gasket when connected together. It is disadvantageous for the gasket face surface of the flange to be damaged by way of scratches, nicks, or dents, as this diminishes the effectiveness of the sealing by the gasket. Thus, the use of a flange protector during storage, shipment, cleaning, or welding of a flange is found useful to protect the gasket face surface.

Devices have been disclosed in the known art that relate to flange protectors. These include devices that have been patented and published in patent application publications. These devices generally relate to flange protectors such as: a flange protector having flexible coupling insert, a corrugated plastic flange protective cover, a flange protector comprising a flexible impact resistant material, and a pinch cap.

These known art devices have several known drawbacks. Some known flange protectors require extensive use of tools to install. While other flange protectors, not requiring the use of tools to install, are made of flimsy material, such as polyethylene or plastic, which is susceptible to damage from pressure washing, sand blasting, or other high impact activities. Further, these flange protectors do not adhere to the flange surface securely, and can easily become dislodged when any pressure is applied to the protector. These known devices fail to utilize a magnetic fastening means which allows the flange protector to be easily installed and removed to the flange surface without the use of tools, while further maintaining stability of the protector during movement or impact of the flange.

In light of the devices disclosed in the known art, it is submitted that the present invention substantially diverges in design elements from the known art and consequently it is clear that there is a need in the art for an improvement to existing flange protector devices. In this regard, the instant invention substantially fulfills these needs.

### SUMMARY OF THE INVENTION

In view of the foregoing disadvantages inherent in the known types of flange protectors now present in the known art, the present invention provides a new magnetic flange protector wherein the same can be utilized for providing convenience for the user when temporarily protecting the surface of a flange without using additional tools, such as bolts or wrenches.

It is therefore an object of the present invention to provide a new and improved magnetic flange protector device that has all of the advantages of the known art and none of the disadvantages. The magnetic flange protector comprises a planar member having an upper surface and a lower surface, a handle secured to the upper surface of the planar member, and a magnet secured to the lower surface of the planar member. The magnet is configured to removable secure to a gasket face surface of a flange. The magnet is secured to the lower surface within a recessed area, thereby allowing the lower surface of the planar member to rest flush against the gasket face surface of the flange.

Another object of the present invention is to provide a magnetic flange protector wherein the planar member is circular having rounded edges and an arcuate shaped handle.

Yet another object of the present invention is to provide a magnetic flange protector wherein a concentric annular seal is secured to the lower surface and a threaded collar is secured to the planar member.

Another object of the present invention is to provide a magnetic flange protector that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the upper surface of the magnetic flange protector.

FIG. 2 shows an exploded view of the lower surface of the magnetic flange protector.

FIGS. 3A, 3B and 3C show bottom views of multiple embodiments of the magnetic flange protector.

FIG. 4 shows a bottom view of an embodiment of the magnetic flange protector, wherein a concentric annular seal is secured thereto.

FIG. 5 shows a perspective view of an embodiment of the magnetic flange protector, wherein a threaded collar is secured thereto.

FIG. 6A and FIG. 6B show perspective views of the magnetic flange protector in a detached and attached position, respectively.

### DETAILED DESCRIPTION OF THE INVENTION

Reference is made herein to the attached drawings. Like reference numerals are used throughout the drawings to depict like or similar elements of the magnetic flange protector. For the purposes of presenting a brief and clear description of the present invention, the preferred embodiment will be discussed as used for protecting the gasket face surface of a metal flange. The figures are intended for representative purposes only and should not be considered to be limiting in any respect.

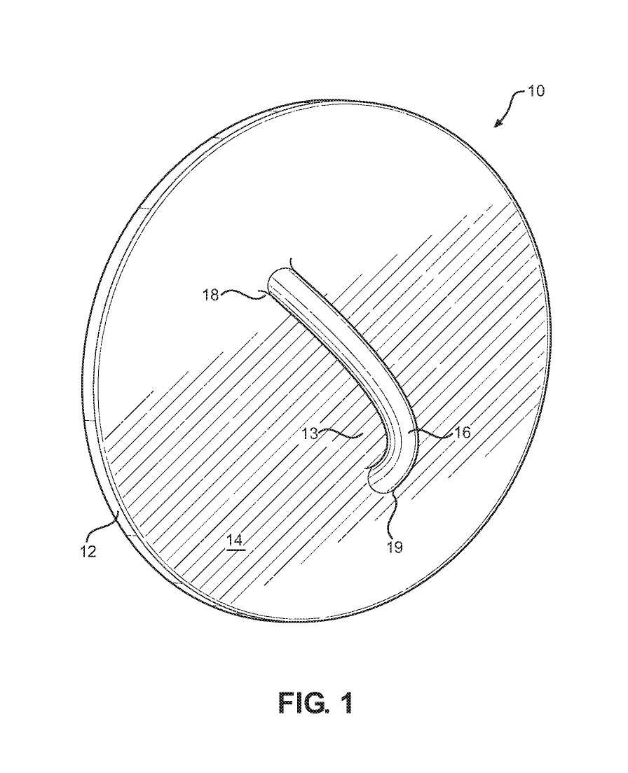

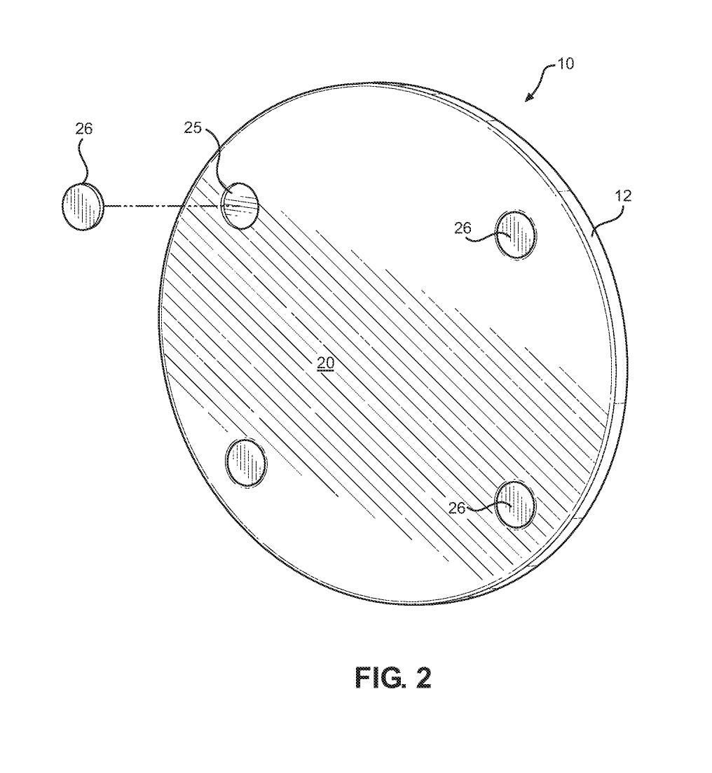

Referring now to FIG. 1 and FIG. 2, there is shown a perspective view of the upper surface and an exploded view of the lower surface of the magnetic flange protector, respectively. The magnetic flange protector 10 comprises a planar member 13 having an upper surface 14 and a lower surface 20. The upper surface 14 has a handle 16 secured thereto. In the illustrated embodiment, the handle 16 comprises a first end 18 and a second end 19 secured to the upper surface 14 of the planar member 13, wherein the handle 16 has an arcuate shape. The arcuate shaped handle 16 is configured to allow the user to easily grip the device. In alternative embodiments, the handle 16 can be any shape, such as rectangular, square, or oval.

In the illustrated embodiment, the planar member 13 comprises a circular shape having a rounded edge 12. The circular shape is configured to match the shape of an interior edge of a gasket face surface of a flange. The lower surface 20 of the planar member 13 is configured to receive a magnet 26. In the illustrated embodiment, a plurality of magnets 26, comprising a circular shape, are secured within a plurality of recessed areas 25 located on a perimeter of the lower surface 20 of the planar member 13. The lower surface 20 is configured to removably secure to the gasket face surface of the flange, such that the lower surface 20 rests flush against the gasket face surface and the perimeter of the lower surface containing the magnets 26 does not extend beyond an interior edge of the gasket face surface. The plurality of magnets 26 are positioned along the perimeter of the lower surface 20 an equidistance from an adjacent magnet, whereby the perimeter is configured to rest flush against and overlay the gasket face surface of the flange when removable secured. Typically, flanges are constructed of a ferrous metal, such as steel. Magnets produce a magnetic force that attracts to ferrous metal. The magnetic attraction between the magnets 26 of the device 10 and the ferrous metal of the gasket face surface of the flange allow the magnetic flange protector 10 to remain secured in place until removed by a user.

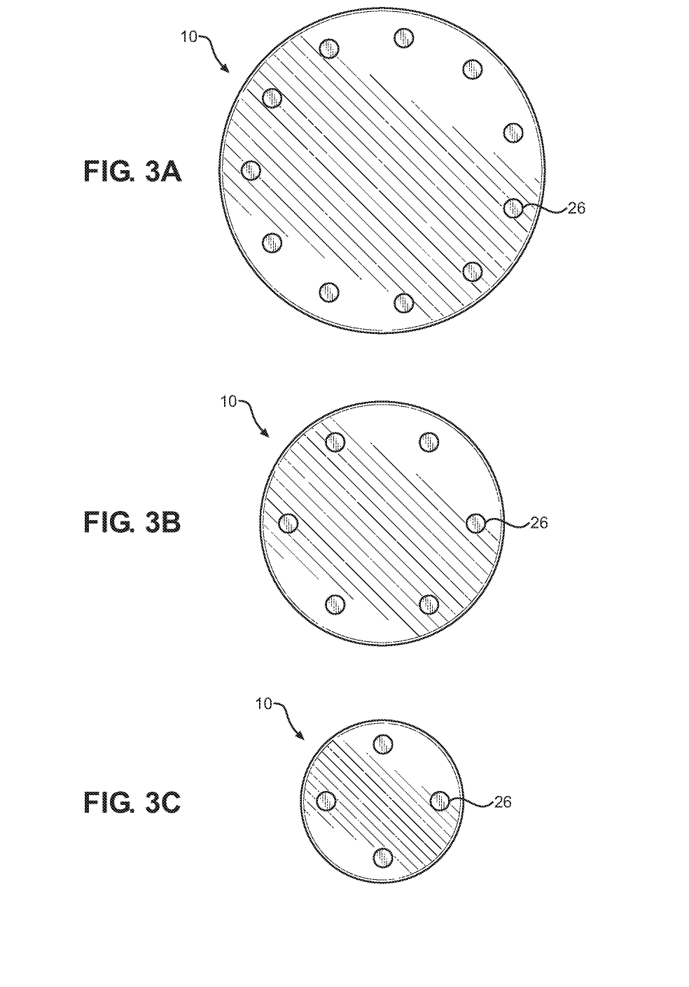

Referring now to FIGS. 3A-3C, shown are bottom views of multiple embodiments of the magnetic flange protector. The magnetic flange protector 10 is configured to removably secure to the gasket face surface of the flange via a magnet 26. The gasket face surface of a flange can vary in both shape and size. In the illustrated embodiments, the lower surface of the magnetic flange protector 10 is configured with multiple magnets 26, such that, as the diameter of the magnetic flange protector 10 increases in size, so do the number of magnets 26 attached to the lower surface of the planar member. As the diameter increases in size for each embodiment 10 so does its weight, thereby necessitating more magnets to increase the magnetic force required to remain removable secure to a corresponding flange gasket face surface.

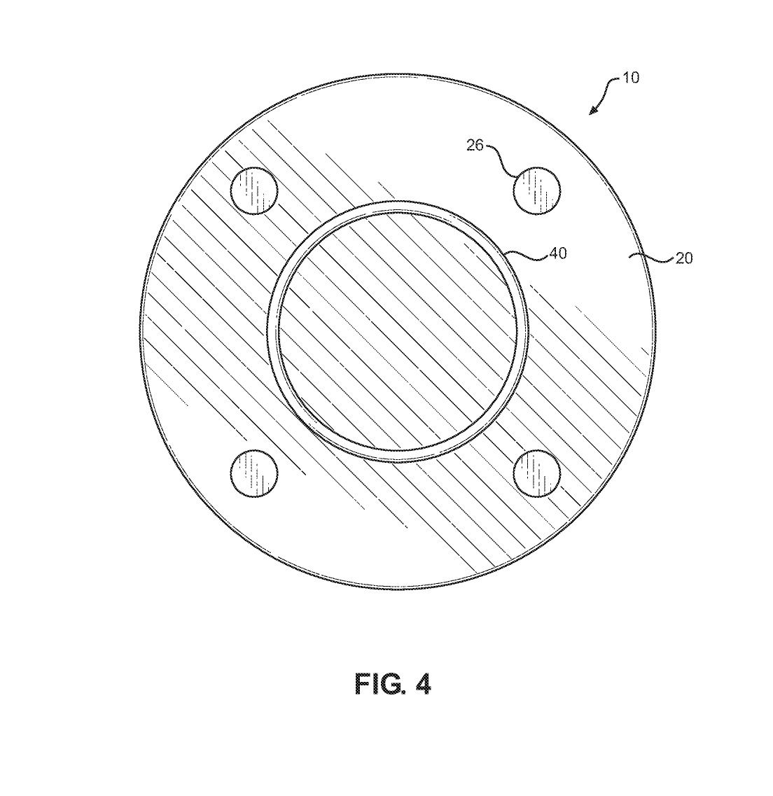

Referring now to FIG. 4, there is shown a bottom view of an embodiment of the magnetic flange protector, wherein a concentric annular seal is secured thereto. In the illustrated embodiment, the magnetic flange protector 10 has a concentric annular seal 40 secured to the lower surface 20 of the planar member. The concentric annular seal 40 is disposed within an inner area of the lower surface 20 of the planar member, wherein the inner area is defined as between the center of the surface of the planar member and the magnets, such that the concentric annular seal fits within a flange pipe. This configuration allows the concentric annular seal 40 to be disposed within the flange pipe thereby creating a fluid tight connection, while allowing the lower surface 20 of the device 10 to remain flush against the gasket face surface of the flange. In the illustrated embodiment, the concentric annular seal 40 is constructed of a resilient material, such as rubber. In alternative embodiments, the concentric annular seal 40 can be made of any material, such as, silicone, metal, or neoprene. The concentric annular seal prevents liquids, solids, or gases from entering or exiting the flange pipe if sealed completely on both ends, while also providing additional protection from damage from the elements.

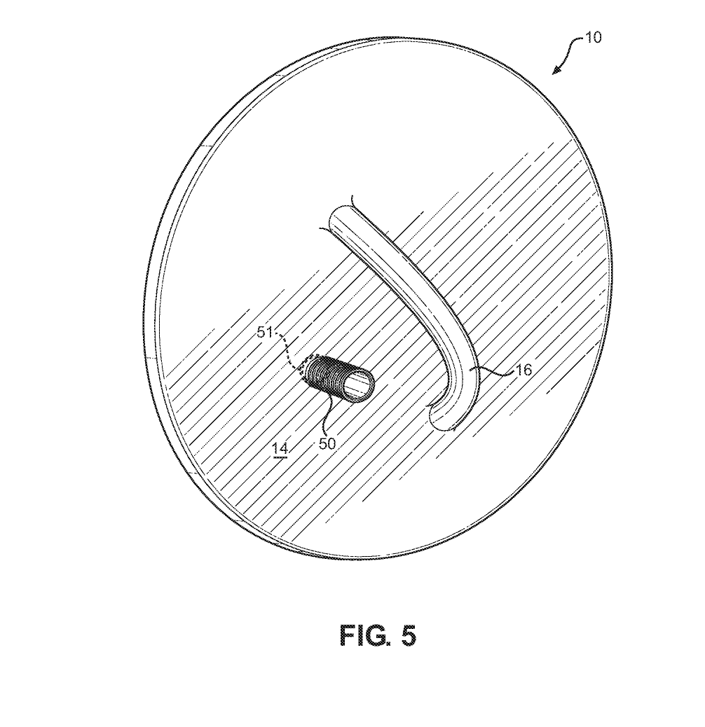

Referring now to FIG. 5, there is shown a perspective view of an embodiment of the magnetic flange protector, wherein a threaded collar is secured thereto. In the illustrated embodiment, a threaded collar 50 is secured to the upper surface 14 of the magnetic flange protector 10 through an aperture 51. The threaded collar 50 is disposed within the aperture 51 offset from the handle 16 and positioned to remain within the flange pipe when the device 10 is connected. The aperture 51 extends from the upper surface 14 through to the lower surface of the planar member. The threaded collar 50 is configured to secure a fastener, such as a threaded hose connection, thereby allowing the flange pipe to be purged with a liquid or a gas, such as argon. The ability to purge a pipe with argon will dissipate oxygen in the pipe, allowing a user to weld another section of the pipe safely. The threaded collar 50 can be any size, such as, a ⅛″ pipe thread fitting. In alternative embodiments, the collar can be any type of fastenable collar, such as a quick connect collar.

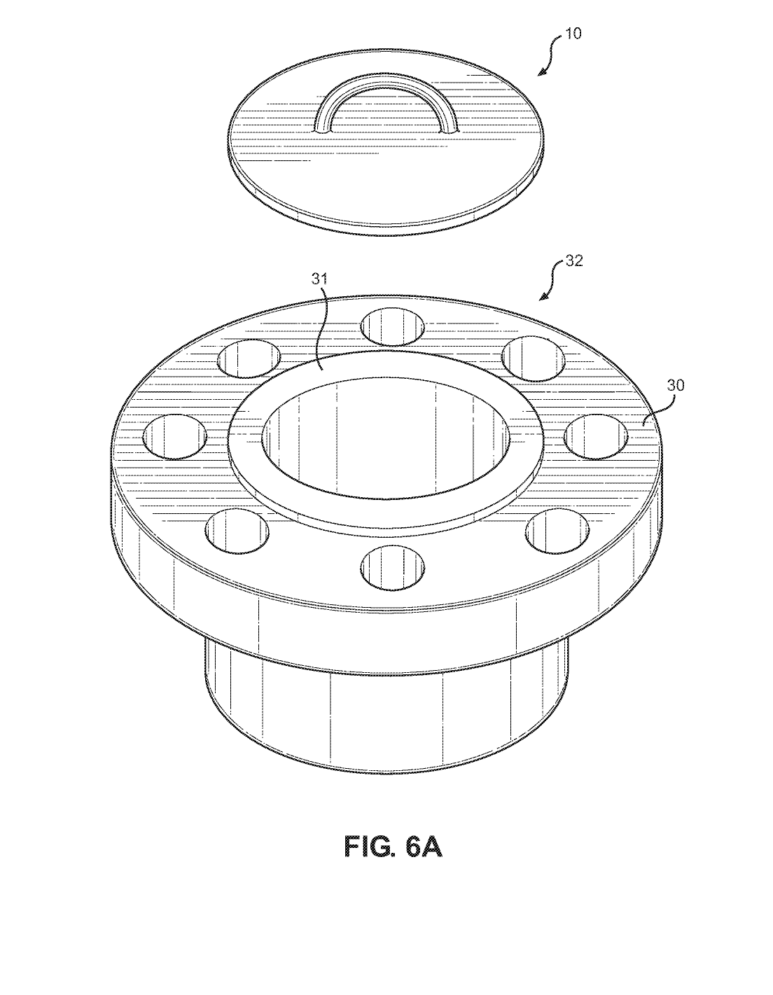

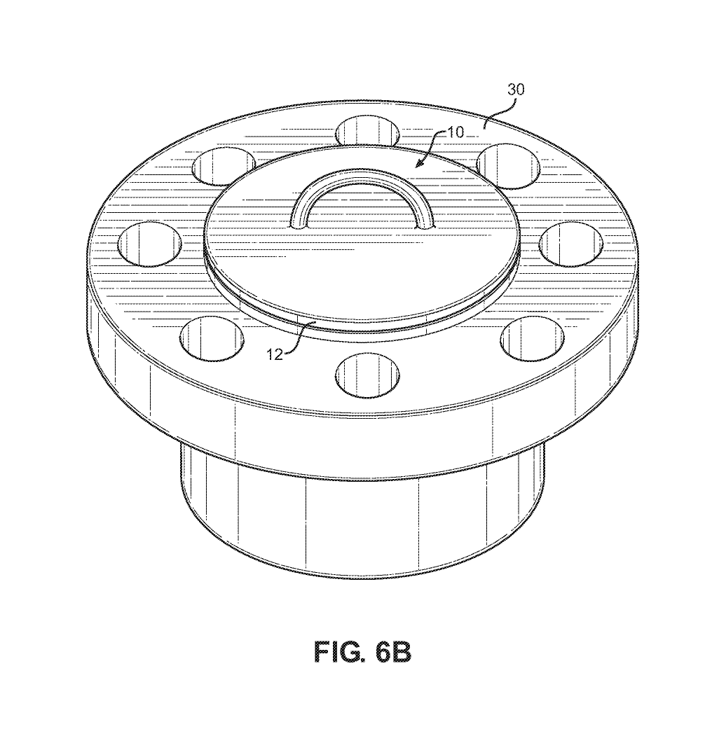

Referring now to FIG. 6A and FIG. 6B, there are shown perspective views of the magnetic flange protector in a detached and attached position, respectively. In the illustrated embodiment, the magnetic flange protector 10 is configured to fit directly over the gasket face surface 31 of the flange pipe 32. When in an attached position, the magnetic flange protector 10 removably secures to the gasket face surface 31 by utilizing the magnetic force of the magnets and their attraction to the ferrous metal of the gasket face surface 31. When attached, the lower surface of the planar member rests flush against the gasket face surface 31, while a hub 30 remains exposed. The rounded edge 12 of the device 10 is adapted to overlay the interior edge of the gasket face surface 31. When in the attached position the flange protector 10 is securely fastened to the machined surface of the flange, preventing it from damage during activities, such as shipping, cleaning, or welding. Once the flange surface is needed for mating to another flange pipe, the magnetic flange protector 10 can be easily removed without the use of tool. A user simply applies an opposing force to the handle thereby releasing the protector 10 from its magnetic attraction to the flange.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A magnetic flange protector, comprising:
a planar member having an upper surface and a lower surface;
a handle secured to the upper surface of the planar member; and
a magnet secured to the lower surface of the planar member;
wherein the lower surface is configured to removably secure to a gasket face surface of a flange, such that the lower surface rests flush against the gasket face surface and a perimeter of the lower surface containing the magnets does not extend beyond an interior edge of the gasket face surface.

2) The magnetic flange protector of claim 1, wherein the magnet is secured to the lower surface within a recessed area, thereby allowing the lower surface to rest flush against the gasket face surface of the flange.

3) The magnetic flange protector of claim 1, wherein the planar member is circular.

4) The magnetic flange protector of claim 1, wherein the planar member comprises rounded edges.

5) The magnetic flange protector of claim 1, wherein the handle has a first end and a second end secured thereto the upper surface.

6) The magnetic flange protector of claim 1, wherein the handle is arcuate shaped.

7) The magnetic flange protector of claim 1, wherein a seal is secured to the lower surface.

8) The magnetic flange protector of claim 7, wherein the seal is a concentric annular seal.

9) The magnetic flange protector of claim 7, wherein the concentric annular seal is made of a resilient material.

10) The magnetic flange protector of claim 1, wherein the planar member contains an aperture.

11) The magnetic flange protector of claim 11, wherein the aperture is configured to secure a collar.

12) The magnetic flange protector of claim 12, wherein the collar is threaded.

13) The magnetic flange protector of claim 1, wherein the magnet is circular.

14) The magnetic flange protector of claim 1, wherein the magnet is a plurality of magnets positioned along an outer perimeter of the lower surface, whereby the outer perimeter is configured to rest flush thereagainst the gasket face surface of the flange.

15) The magnetic flange protector of claim 1, wherein the concentric annular seal is affixed between the center of the device and the magnet.

16) The magnetic flange protector of claim 1, wherein the plurality of magnets are positioned an equidistance from an adjacent magnet.
